(19) United States
(12) Patent Application Publication
(10) Pub. No.: US 2025/0355275 A1
(43) Pub. Date: Nov. 20, 2025

(54) SYSTEM AND METHOD FOR GENERATING A THREE-DIMENSIONAL (3D) EYEGLASSES MODEL

(71) Applicant: META PLATFORMS, INC., Menlo Park, CA (US)

(72) Inventor: Shenchang Eric Chen, Bellevue, WA (US)

(73) Assignee: META PLATFORMS, INC., Menlo Park, CA (US)

(21) Appl. No.: 17/719,413

(22) Filed: Apr. 13, 2022

Related U.S. Application Data
(60) Provisional application No. 63/183,956, filed on May 4, 2021.

(51) Int. Cl. G02C 7/02; G06T 15/04; G06T 17/10

(52) U.S. Cl. CPC G02C 7/028; G02C 7/027; G06T 15/04; G06T 17/10

(57) ABSTRACT

In some embodiments, a system includes a processor; and a memory in communication with the processor for storing instructions, which when executed by the processor causes the device to receive a frontal frame component image of a frontal frame of a pair of eyeglasses; receive a temple component image of a temple component of the pair of eyeglasses; and use the frontal frame component image and the temple component image to generate a three-dimensional (3D) model of the pair of eyeglasses.

### CROSS-REFERENCE TO RELATED APPLICATION

The present application claims the benefit of U.S. Provisional Application No. 63/183,956, entitled “Creation of a 3D Eyeglasses Model from Photos” filed May 4, 2021. U.S. Provisional Application No. 63/183,956 is expressly incorporated herein by reference in its entirety.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Trying eyeglasses on virtually generally requires the rendering of a three-dimensional (3D) eyeglasses model on a person's face model to visualize the manner in which the eyeglasses fit on the face of the person from different viewing directions. 3D computer-aided design (CAD) models of eyeglasses are often not available for virtual try-on use and even when a 3D model of eyeglasses is available for virtual try-on use, the 3D model of the eyeglasses may not contain the material properties, color, or surface texture needed to produce a high quality, photo realistic 3D rendering of the eyeglasses.

### BRIEF DESCRIPTION OF THE DRAWINGS

FIG. 1 illustrates a processing system used to generate a three-dimensional (3D) eyeglasses model on the face of a user in accordance with some embodiments.

FIG. 2 illustrates a 3D eyeglasses model generation system of FIG. 1 in accordance with some embodiments.

FIG. 3 illustrates a pair of eyeglasses in accordance with some embodiments.

FIG. 4 illustrates an image of a frontal frame component of the pair of eyeglasses of FIG. 3 with a background removed and component markers added in accordance with some embodiments.

FIG. 5 illustrates an image of a temple component of the pair of eyeglasses of FIG. 3 with a background removed and a component marker added in accordance with some embodiments.

FIG. 6A illustrates the frontal frame component image of the pair of eyeglasses of FIG. 3 with detected contours and a bounding box in accordance with some embodiments.

FIG. 6B illustrates outer and inner surfaces of the frontal frame component of the pair of eyeglasses of FIG. 3 constructed with curved rectangular grids in accordance with some embodiments.

FIG. 7 illustrates an exterior contour surface and hole contour surfaces of the frontal frame component of FIG. 6B created with surface of revolution from a profile with beveled edges in accordance with some embodiments.

FIG. 8 illustrates an opacity map created from the lens contours of FIG. 6A in accordance with some embodiments.

FIG. 9 illustrates a rendering of a reconstructed 3D eyeglasses model in accordance with some embodiments.

FIG. 10 is a flow diagram illustrating a method for generating a 3D eyeglasses model in accordance with some embodiments.

### DETAILED DESCRIPTION

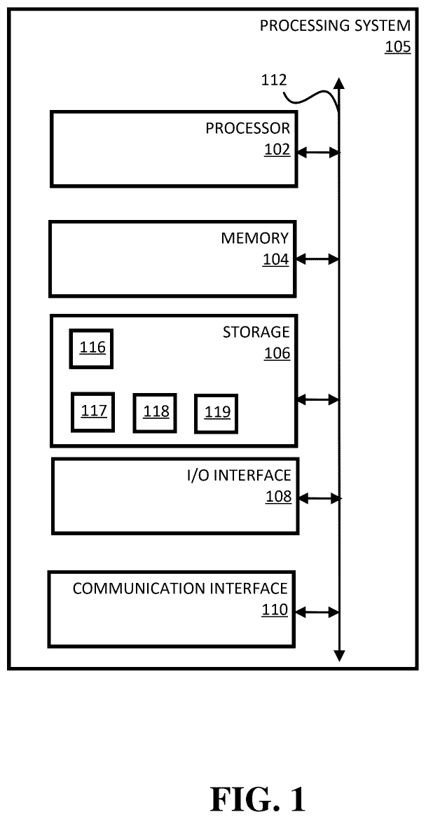

FIG. 1 illustrates an example processing system 105 that is used to generate an eyeglasses model on a face of a user in accordance with some embodiments. In some embodiments, one or more processing systems 105 may perform one or more steps of one or more methods described or illustrated herein. In particular embodiments, one or more processing systems 105 provide functionality described or illustrated herein. In particular embodiments, software running on one or more processing systems 105 performs one or more steps of one or more methods described or illustrated herein or provides functionality described or illustrated herein. Particular embodiments include one or more portions of one or more processing systems 105. Herein, reference to a computer system may encompass a computing device, and vice versa, where appropriate. Moreover, reference to a computer system may encompass one or more computer systems, where appropriate.

This disclosure contemplates any suitable number of processing systems 105. This disclosure contemplates processing system 105 taking any suitable physical form. As example and not by way of limitation, processing system 105 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, processing system 105 may include one or more processing systems 105; be unitary or distributed: span multiple locations; span multiple machines; span multiple data centers; or reside in a cloud, which may include one or more cloud components in one or more networks. Where appropriate, one or more processing systems 105 may perform without substantial spatial or temporal limitation one or more steps of one or more methods described or illustrated herein. As an example and not by way of limitation, one or more processing systems 105 may perform in real time or in batch mode one or more steps of one of more methods described or illustrated herein. One or more processing systems 105 may perform at different times or at different locations one or more steps of one or more methods described or illustrated herein, where appropriate.

In some embodiments, processing system 105 includes a processor 102, memory 104, storage 106, an input/output (I/O) interface 108, a communication interface 110, and a bus 112. In some embodiments, the processing system described herein may be considered a computer system. Although this disclosure describes and illustrates a particular computer system having a particular number of particular components in a particular arrangement, this disclosure contemplates any suitable computer system having any suitable number of any suitable components in any suitable arrangement.

In some embodiments, processor 102 includes hardware for executing instructions, such as those making up a computer program. As an example and not by way of limitation, to execute instructions, processor 102 may retrieve (or fetch) the instructions from an internal register, an internal cache, memory 104, or storage 106; decode and execute them; and then write one or more results to an internal register, an internal cache, memory 104, or storage 106. In particular embodiments, processor 102 may include one or more internal caches for data, instructions, or addresses. This disclosure contemplates processor 102 including any suitable number of any suitable internal caches, where appropriate. As an example and not by way of limitation, processor 102 may include one or more instruction caches, one or more data caches, and one or more translation lookaside buffers (TLBs). Instructions in the instruction caches may be copies of instructions in memory 104 or storage 106, and the instruction caches may speed up retrieval of those instructions by processor 102. Data in the data caches may be copies of data in memory 104 or storage 106 for instructions executing at processor 102 to operate on; the results of previous instructions executed at processor 102 for access by subsequent instructions executing at processor 102 or for writing to memory 104 or storage 106; or other suitable data. The data caches may speed up read or write operations by processor 102. The TLBs may speed up virtual-address translation for processor 102. In particular embodiments, processor 102 may include one or more internal registers for data, instructions, or addresses. This disclosure contemplates processor 102 including any suitable number of any suitable internal registers, where appropriate. Where appropriate, processor 102 may include one or more arithmetic logic units (ALUs); be a multi-core processor; or include one or more processors 102. Although this disclosure describes and illustrates a particular processor, this disclosure contemplates any suitable processor.

In some embodiments, memory 104 includes main memory for storing instructions for processor 102 to execute or data for processor 102 to operate on. As an example and not by way of limitation, processing system 10S may load instructions from storage 106 or another source (such as, for example, another processing system 105) to memory 104. Processor 102 may then load the instructions from memory 104 to an internal register or internal cache. To execute the instructions, processor 102 may retrieve the instructions from the internal register or internal cache and decode them. During or after execution of the instructions, processor 102 may write one or more results (which may be intermediate or final results) to the internal register or internal cache. Processor 102 may then write one or more of those results to memory 104. In particular embodiments, processor 102 executes only instructions in one or more internal registers or internal caches or in memory 104 (as opposed to storage 106 or elsewhere) and operates only on data in one or more internal registers or internal caches or in memory 104 (as opposed to storage 106 or elsewhere). One or more memory buses (which may each include an address bus and a data bus) may couple processor 102 to memory 104. Bus 112 may include one or more memory buses, as described below. In particular embodiments, one or more memory management units (MMUs) reside between processor 102 and memory 104 and facilitate accesses to memory 104 requested by processor 102. In particular embodiments, memory 104 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 104 may include one or more memories 104, where appropriate. Although this disclosure describes and illustrates particular memory, this disclosure contemplates any suitable memory.

In some embodiments, storage 106 includes mass storage for data or instructions. In some embodiments, storage 106 includes an eyeglasses model generation system 116 (described further in detail herein). In some embodiments, eyeglasses model generation system 116 is software configured to place a 3D eyeglasses model on a face model of a user. As an example and not by way of limitation, storage 106 may include a hard disk drive (HDD), a floppy disk drive, flash memory, an optical disc, a magneto-optical disc, magnetic tape, or a Universal Serial Bus (USB) drive or a combination of two or more of these. Storage 106 may include removable or non-removable (or fixed) media, where appropriate. Storage 106 may be internal or external to processing system 105. where appropriate. In particular embodiments, storage 106 is non-volatile, solid-state memory. In particular embodiments, storage 106 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 106 taking any suitable physical form. Storage 106 may include one or more storage control units facilitating communication between processor 102 and storage 106, where appropriate. Where appropriate, storage 106 may include one or more storages 106. Although this disclosure describes and illustrates particular storage, this disclosure contemplates any suitable storage.

In some embodiments, I/O) interface 108 includes hardware, software, or both, providing one or more interfaces for communication between processing system 105 and one or more I/O devices. Processing system 105 may include one or more of these I/O devices, where appropriate. One or more of these I/O devices may enable communication between a person and processing system 105. As an example and not by way of limitation, an I/O) device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. In some embodiments, I/O devices may include a camera configured to digitally photograph a pair of eyeglasses, such as, for example, eyeglasses 341. This disclosure contemplates any suitable I/O devices and any suitable I/O interfaces 108 for them. Where appropriate, I/O interface 108 may include one or more device or software drivers enabling processor 102 to drive one or more of these I/O devices. I/O interface 108 may include one or more I/O interfaces 108, where appropriate. Although this disclosure describes and illustrates a particular I/O interface, this disclosure contemplates any suitable I/O interface.

In some embodiments, communication interface 110 includes hardware, software, or both providing one or more interfaces for communication (such as, for example, packet-based communication) between processing system 105 and one or more other processing systems 105 or one or more networks. As an example and not by way of limitation, communication interface 110 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 110 for it. As an example and not by way of limitation, processing system 105 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, processing system 105 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Processing system 105 may include any suitable communication interface 110 for any of these networks, where appropriate. Communication interface 110 may include one or more communication interfaces 110, where appropriate. Although this disclosure describes and illustrates a particular communication interface, this disclosure contemplates any suitable communication interface.

In some embodiments, bus 112 includes hardware, software, or both coupling components of processing system 105 to each other. As an example and not by way of limitation, bus 112 may include an Accelerated Graphies Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 112 may include one or more buses 112, where appropriate. Although this disclosure describes and illustrates a particular bus, this disclosure contemplates any suitable bus or interconnect.

As described herein, a computer-readable non-transitory storage medium or media may include one or more semiconductor-based or other integrated circuits (ICs) (such, as for example, field-programmable gate arrays (FPGAs) or application-specific ICs (ASICs), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

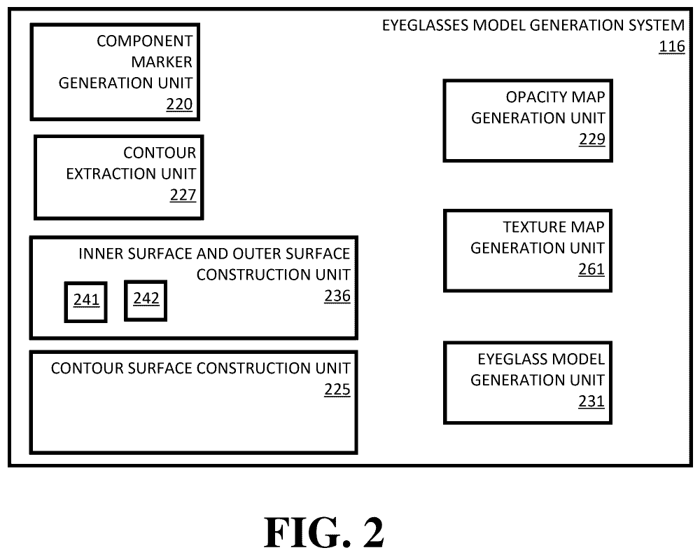

FIG. 2 illustrates an eyeglasses model generation system 116 of the processing system 105 of FIG. 1 in accordance with some embodiments. In some embodiments, the eyeglasses model generation system 116 is utilized to generate a 3D eyeglasses model 399 (illustrated by example in FIG. 9) on a face model of a user in accordance with some embodiments. In some embodiments, the eyeglasses model generation system 116 includes a component marker generation unit 220, a contour extraction unit 227, an inner surface and outer surface construction unit 236, a contour surface construction unit 225, opacity map generation unit 229, a texture map generation unit 261, and an eyeglasses model generation unit 231. In some embodiments, the component marker generation unit 220, the inner surface and outer surface construction unit 236, the contour surface construction unit 225, the contour extraction unit 227, the opacity map generation unit 229, the texture map generation unit 261, and the eyeglasses model generation unit 231 are software components collectively configured to generate the 3D eyeglasses model 399 as described further herein.

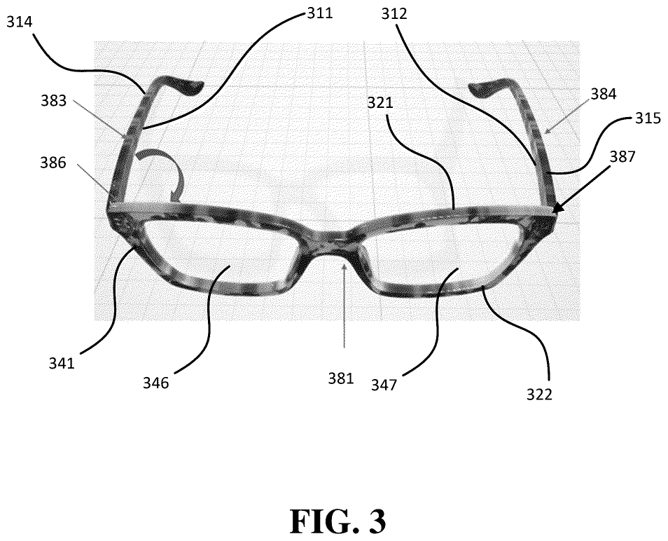

In some embodiments, as part of the 3D eyeglasses model 399 generation process, eyeglasses model generation system 116 is configured to generate the components of a pair of eyeglasses, e.g., a frontal frame component (frontal frame), a left temple component (left temple), and a right temple component (right temple), and optionally the lenses of the eyeglasses when the eyeglasses are not transparent. FIG. 3 illustrates a pair of eyeglasses 341 that are reconstructed by the eyeglasses model generation system 116 in accordance with some embodiments.

In some embodiments, the eyeglasses 341 include a frontal frame component 381, a lens 346, a lens 347, a temple component 384 (e.g., left temple component), and a temple component 383 (e.g., right temple component). In some embodiments, the frontal frame component 381, the left temple component 384, and the right temple component 383 of the pair of eyeglasses 341 are all reconstructed by eyeglasses model generation system 116 to generate the 3D eyeglasses model 399 in accordance with some embodiments.

In some embodiments, as illustrated in FIG. 3, the frontal frame component 381 is a front frame of the eyeglasses that holds the lenses (e.g., lens 347 and lens 347) of the eyeglasses 341. In some embodiments, the frontal frame component 381 includes a bridge that connects the rims of the eyeglasses 341. In some embodiments, the left temple component 384 and the right temple component 383 are the elongated stems of the eyeglasses 341 that couple the frontal frame component 381 to the ears of the user (or wearer) of the eyeglasses 341. In some embodiments, the frontal frame component 381 is coupled to the left temple component 384 at a left hinge point 387 and the right temple component 383 at a right hinge point 386.

In some embodiments, the left temple component 384 and the right temple component 383 are configured to rotate at left hinge point 387 and right hinge point 386, respectively, to fold or open the temple components. In some embodiments, since the left temple component 384 and the right temple component 383 are symmetrical, only a single copy of a temple component need be procedurally constructed by the eyeglasses model generation system 116, with the other temple component being formulated as a mirrored copy of the first temple component (e.g., via a transformation) using eyeglasses model generation system 116.

In some embodiments, in order to generate the 3D eyeglasses model 399, eyeglasses model generation system 116 is configured to generate the frontal frame component 381, the left temple component 384, and the right temple component 383 by constructing an outer surface, an inner surface, and a contour surface for each component. That is, in some embodiments, each of the components (e.g., frontal frame component 381, the left temple component 384, and the right temple component 383) are constructed by eyeglasses model generation system 116 using at least three surfaces, e.g., the outer surface, the inner surface, and one or more contour surfaces.

In some embodiments, the outer surfaces and the inner surfaces are curved surfaces translated by the thickness of the eyeglasses frame in the direction perpendicular to the eyeglasses 341. In some embodiments, the outer surface may be defined as the surface that is furthest away from the face of the user of the eyeglasses 341. In some embodiments, the inner surface may be defined as the surface that is closest to the face of the user of the eyeglasses 341. In some embodiments, the contour surfaces may be defined as surfaces that trace each of the frame contours of the eyeglasses between the outer and the inner surfaces.

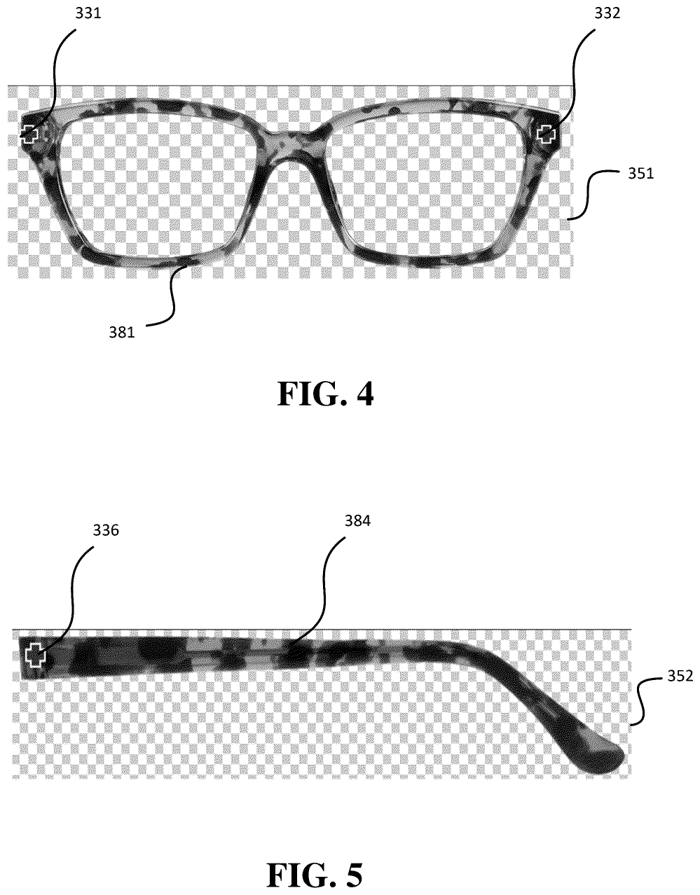

In some embodiments, since the frontal frame component has at least three frame contours (e.g., an exterior frame contour and the two hole contours for the lenses, where each contour may create a contour surface), eyeglasses model generation system 116 is configured to generate an exterior frame contour surface, a first lens hole contour surface, and a second lens hole contour surface (as illustrated in FIG. 4). In some embodiments, additional contours may be used to generate the 3D frames using a similar technique described herein (since some eyeglasses frames may have additional hole contours (e.g., in the nose bridge region)).

In some embodiments, after the contour surfaces are constructed, the eyeglasses model generation system 116 generates opacity maps and texture maps for each surface reconstructed by the eyeglasses model generation system 116. In some embodiments, the eyeglasses model generation system 116 uses the combination of the reconstructed surfaces, the opacity maps, and texture maps to generate the 3D eyeglasses model 399.

In some embodiments, with reference to FIG. 2, in order to initiate the generation of the 3D eyeglasses model 399, processing system 105 requests user input a frontal frame component image 118 of eyeglasses 341, a temple component image 119 of eyeglasses 341, and eyeglasses specifications 117 for the eyeglasses 341. In some embodiments, the eyeglasses specifications 117 are specifications that correspond to a pair of eyeglasses, such as, for example, eyeglasses 341 of FIG. 3, that provide measurements and other physical properties of the eyeglasses. In some embodiments, the eyeglasses specifications 117 may be obtained by the processing system 105 by having the user take physical measurements of the eyeglasses 341 with, for example, a ruler or a caliper, or by accessing input manufacturer specifications provided by the manufacturer of eyeglasses 341. In some embodiments, the eyeglasses specifications 317 may include, but are not limited to, a distance between left/right hinge center points of the eyeglasses 341, a distance between left/right nose bridge points of the eyeglasses 341, a temple length from the hinge point to the opposite end of the temple of the eyeglasses 341, a nose bridge bulge distance of the eyeglasses 341, a frontal frame curvature of the eyeglasses 341 in an x-direction and a y-direction (offset from a base plane), a temple curvature of the temples of the eyeglasses 341 (offset from the base plane), a front frame thickness (average) of the eyeglasses 341, a temple thickness (average) of the temples of the eyeglasses 341, a bevel radii for the frontal frame and temples of the eyeglasses 341, a lens height (distance between top and bottom points of the lens), a lens opacity and tint of the lenses of eyeglasses 341, a lens gradient minimum and maximum values (optional) of the lenses of eyeglasses 341, a glossiness and metallic factor of the frame of the eyeglasses 341, a nose pad style of the eyeglasses 341, and a nose pad offset distance from frame of the eyeglasses 341. In some embodiments, the above specifications (e.g., eyeglasses specifications 117) are stored in storage 106 and provided as input to eyeglasses model generation system 116 for use in generating the 3D eyeglasses model 399.

In some embodiments, in addition to receiving the eyeglasses specifications 117 of the eyeglasses 341, the processing system 105 receives the frontal frame component image 118 of eyeglasses 341 and the temple component image 119 of eyeglasses 341. In some embodiments, the frontal frame component image 118 is a digital frontal frame image or digital photo of the frontal frame component 381 of eyeglasses 341, as illustrated by example in FIG. 4. In some embodiments, the temple component image 119 is a digital image or photo of the temple component 383 or temple component 384 of eyeglasses 341, as illustrated by example in FIG. 5. In some embodiments, the frontal frame component image 118 and the temple component image 119 are stored in storage 106 for use by the eyeglasses model generation system 116.

In some embodiments, the frontal frame component image 118 and the temple component image 119 are photographed by the user with, for example, a digital photo camera from a direction perpendicular to the frontal frame component 381 of eyeglasses 341 (e.g., pointing the digital photo camera towards the outer surface of frontal frame component 381) and from a direction perpendicular to the temple component 384 (e.g., pointing the digital photo camera towards temple outer surface 315 of the temple component 384), as illustrated in FIG. 4 and FIG. 5, respectively.

In some embodiments, eyeglasses model generation system 116 may be configured to correct directional variation in the digital images photographed by the user. In some embodiments, for example, directional variation may be corrected by the eyeglasses model generation system 116 using inverse perspective warping. In some embodiments, inverse perspective warping is a warping technique used to rectify the perspective distortion caused by a photo taken at a non-perpendicular angle. In some embodiments, eyeglasses model generation system 116 may be configured to correct lens barrel distortion in the digital images photographed by the user. In some embodiments, lens barrel distortion is a type of image distortion that typically occurs when a wide-angle lens is used to ascertain the digital images of the eyeglasses 341. In some embodiments, the lens distortion may be corrected by the eyeglasses model generation system 116 using inverse barrel projection when, for example, the focal length of the lens is known or can be estimated.

In some embodiments, upon receipt of the frontal frame component image 118 and the temple component image 119, eyeglasses model generation system 116 is configured to remove the background and lens holes from the frontal frame component image 118 and the background from the temple component image 119, such that only the frontal frame component 381 and temple component 384 remain in the images. In some embodiments, when, for example, the digital photos are taken with a chroma keyed background (e.g., green), the background may be removed by eyeglasses model generation system 116. Examples of the digital images with the background and lens holes removed by the eyeglasses model generation system 116 are illustrated in the frontal frame component image 118 of FIG. 4 and temple component image 119 of FIG. 5. In some embodiments, the frontal frame component image 118 and the temple component image 119 are provided to component marker generation unit 220 of eyeglasses model generation system 116 for further processing.

In some embodiments, component marker generation unit 220 receives the eyeglasses specifications 117, the frontal frame component image 118, and the temple component image 119 and commences the process of generating component markers (e.g., frontal frame marker 331, frontal frame marker 332, and temple marker 336) on the frontal frame component 381 and the temple component 384 (as illustrated in FIG. 4 and FIG. 5). In some embodiments, a component marker is a marker placed on the components of the images by the component marker generation unit 220 that, along with the eyeglasses specifications 117, is used by the eyeglasses model generation system 116 to generate a true-to-scale 3D eyeglasses model 399. In some embodiments, component marker generation unit 220 is software configured to generate the component markers (e.g., the frontal frame marker 331, the frontal frame marker 332, and the temple marker 336) on the component images (e.g., frontal frame component image 118 and temple component image 119). In some embodiments, component marker generation unit 220 generates the component markers on the digital images by using an operator that maps to marker information provided in the eyeglasses specifications 217 or physical markers placed on the eyeglasses 341 by the user. In some embodiments, the component marker generation unit 220 detects the physical markers placed on the eyeglasses 341 by the user during the capturing of the frontal frame component image 118 and the temple component image 119.

In some embodiment, the component markers (or image markers) generated by the component marker generation unit 220 may be generated or located at, for example, a left hinge center point and a right hinge center point on the frontal frame component 381, a nose pad left center point and nose pad right center point on the frontal frame component 381, a nose bridge left and a nose bridge right point on the frontal frame component 381, and temple hinge center points on the temple component 384. In some embodiments, as described herein, the component marker generation unit 220 generates the frontal frame marker 331 and the frontal frame marker 332 at the left hinge center point and the right hinge center point on the frontal frame component 381 and the temple marker 336 at the temple hinge center point on temple component 384. FIG. 4 illustrates the frontal frame marker 331 and the frontal frame marker 332 generated by eyeglasses model generation system 116 on frontal frame component 381 that are used to generate the 3D eyeglasses model 399 in accordance with some embodiments. FIG. 5 illustrates the temple marker 336 generated by eyeglasses model generation system 116 on temple component 384 that is used to generate the 3D eyeglasses model 399 in accordance with some embodiments. In some embodiments, as stated previously, the component markers (e.g., frontal frame marker 331, frontal frame marker 332, and temple marker 336) together with the 3D eyeglasses specifications 117 described herein, allow the eyeglasses model generation system 116 to generate the true-to-scale 3D eyeglasses model 399, as illustrated in, for example, FIG. 9.

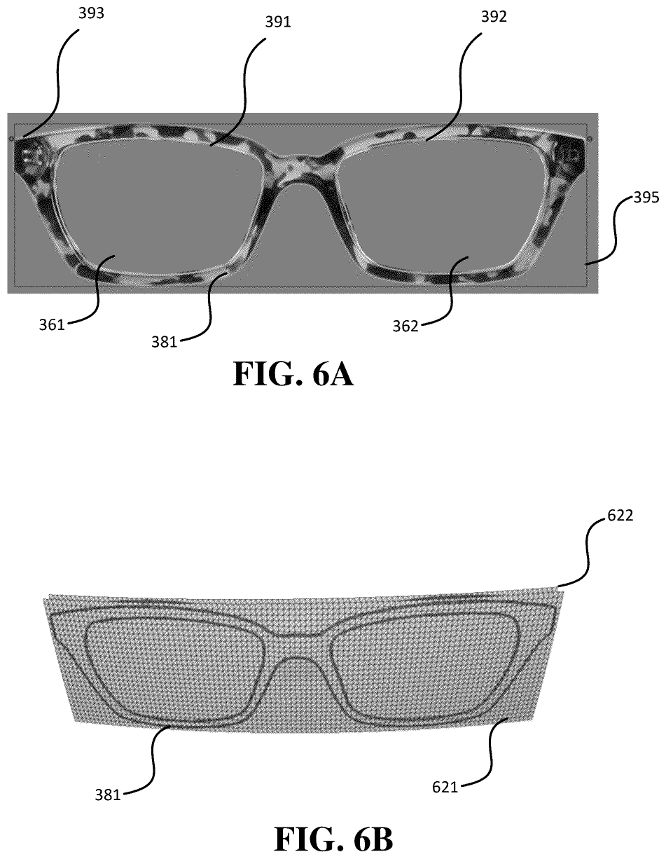

In some embodiments, after or while generating the component markers, contour extraction unit 227 receives the frontal frame component image 118 and the temple component image 119 and commences the process of detecting and extracting contours from the frontal frame component image 118 and the temple component image 119. In some embodiments, contour extraction unit 227 is software configured to detect and extract contours from the received digital images (e.g., the frontal frame component image 118 and the temple component image 119). In some embodiments, contour extraction unit 227 is configured to use the OpenCV function “findContours” to detect and extract the contours from the received images. In some embodiments, the OpenCV function “findContours” is an open source function that is configured to find contours in a digital image. In some embodiments, the contour extraction unit 221 is configured to extract the contours from the alpha channel of the received images. In some embodiments, using the findContours function, the contour extraction unit 227 extracts the exterior contour 393, the lens hole contour 391, and the lens hole contour 392 from the frontal frame component image 118, as illustrated in FIG. 6A.

In some embodiments, in order to determine which of the contours extracted by the contour extraction unit 227 is the exterior contour 393, the contour extraction unit 227 is configured to determine the length of each of the detected contours and assess each of the contours to determine which of the extracted contours has the greatest length (e.g., determining the longest contour length by comparing the lengths of each extracted contour). In some embodiments, when the contour extraction unit 227 determines that a specific contour has the greatest length, that contour is selected as the exterior contour 393 and the remaining contours are selected as lens hole contours (e.g., lens hole contour 391 and lens hole contour 392). In some embodiments, the longest contour is considered the exterior contour 393 and the remaining contours are considered hole contours (e.g., lens hole contour 391 and lens hole contour 392). FIG. 6A illustrates the exterior contour 393, the lens hole contour 391, and the lens hole contour 392 used to generate the 3D eyeglasses model 399 in accordance with some embodiments.

In some embodiments, the contour extraction unit 227 may be configured to “smooth” or resample the points that represent each contour to create a desired predetermined smoothness and number of points. That is, in some embodiments, the detected contour of points may be smoothed and resampled by contour extraction unit 227 to create the desired smoothness and the desired number of points that represent the extracted contours. In some embodiments, when the contour points are altered by the contour extraction unit 227, a corresponding alpha map may be modified by the contour extraction unit 227 to match the altered contours. In some embodiments, the extracted contours, e.g., the exterior contour 393, the lens hole contour 391, and the lens hole contour 392 are provided to contour surface construction unit 225 to construct the surfaces (e.g., inner surfaces and outer surfaces) of the 3D eyeglasses model 399.

In some embodiments, after the exterior contour 393, the lens hole contour 391, and the lens hole contour 392 have been extracted by the contour extraction unit 227, the inner surface and outer surface construction unit 236 utilizes the extracted contours to generate the outer surfaces (e.g., frontal frame outer surface 322, temple outer surface 314, and temple outer surface 315) and inner surfaces (e.g., frontal frame inner surface 321, temple inner surface 311, and temple inner surface 312). In some embodiments, inner surface and outer surface construction unit 236 is software configured to construct the outer surfaces and inner surfaces of the 3D eyeglasses model 399 using the contours generated by the contour extraction unit 227 and the eyeglasses specifications 117.

In some embodiments, inner surface and outer surface construction unit 236 is configured to utilize a bounding box generation unit 241 and a grid surface generation unit 242 to generate inner surfaces (e.g., frontal frame inner surface 321, temple inner surface 311, and temple inner surface 312) and the outer surfaces (frontal frame outer surface 322, temple outer surface 314, and temple outer surface 315). In some embodiments, the bounding box generation unit 241 is software configured to generate a bounding box around a contour that is input into the bounding box generation unit 241. In some embodiments, the grid surface generation unit 242 is software configured to generate grid surfaces of the inner surfaces and the outer surfaces of the 3D eyeglasses model 399 using the bounding boxes generated by bounding box generation unit 241.

In some embodiments, for example, with reference to the exterior contour 393 extracted by the contour extraction unit 227, bounding box generation unit 241 generates a bounding box 395 around the exterior contour 393. In some embodiments, the bounding box generation unit 241 uses the exterior contour 393 as input to find the bounding box 395 around the exterior contour 393. Similarly, in some embodiments, for an exterior contour generated by the contour extraction unit 227 for the temple component 384 (not shown), the bounding box generation unit 241 generates a bounding box (not shown) around the exterior contour of the temple component 384. In some embodiments, since the temple component 383 is symmetric to temple component 384 and mirrors temple component 384, it is not necessary for bounding box generation unit 241 to generate a third bounding box around the opposite temple component, as the transformed results for temple component 384 can be used for opposite temple component 383 since both temple components are symmetrical.

In some embodiments, after the bounding box generation unit 241 generates the bounding boxes around the contours, inner surface and outer surface construction unit 236 uses the grid surface generation unit 242 to generate grid surfaces using the bounding boxes that correspond to the contours extracted by the contour extraction unit 227. In some embodiments, for example, with reference to the frontal frame exterior contour 393, after bounding box generation unit 241 generates the bounding box 395 around the frontal frame exterior contour 393, inner surface and outer surface construction unit 236 uses grid surface generation unit 242 to create rectangular grid surfaces using the bounding box 395 with a pre-defined grid size and margins around the bounding box 395. Examples of rectangular grid surfaces (e.g., rectangular grid surface 621 and rectangular grid surface 622) generated by the inner surface and outer surface construction unit 236 for the frontal frame exterior contour 393 are illustrated in FIG. 6B. As described further herein, the rectangular grid surface 621 and the rectangular grid surface 622 are curved by the inner surface and outer surface construction unit 236 to account for the curvature of the eyeglasses 341.

In some embodiments, as stated previously, since the eyeglasses 341 are generally curved by design, the grid surface generation unit 242 is configured to curve the rectangular grid surfaces to generate the curved rectangular grid surface 621 and the curved rectangular grid surface 622. In some embodiments, the grid surface generation unit 242 is configured to curve the grid surfaces according to curvature-related information provided in the eyeglasses specifications 117. In some embodiments, the curvature-related information of the eyeglasses specifications 117 is used by the grid surface generation unit 242 to approximate the bending of, for example, the frontal frame component 381 (as illustrated in FIG. 6B), and to approximate the bending of temple component 384 (not shown). In some embodiments, the grid surface generation unit 242 curves the rectangular grid surface using the eyeglasses specifications 117 to generate the curved rectangular grid surface 621 and the curved rectangular grid surface 622 (as illustrated in FIG. 6B). Similarly, the grid surface generation unit 242 generates curved rectangular surfaces for temple component 384 and its mirrored equivalent (not shown).

In some embodiments, the outer surfaces and the inner surfaces may be composed of a rectangular grid of triangles represented by the curved rectangular grid surface 621 and the curved rectangular grid surface 622. In some embodiments, the geometrical configuration of the inner surface and outer surface may be the same (e.g., have the same geometry), but may be offset by the frame thickness of the eyeglasses 341 provided from the eyeglasses specifications 117. As stated previously, FIG. 6B illustrates the rectangular grid surface 621 and the rectangular grid surface 622 offset by the frame thickness and constructed by the inner surface and outer surface construction unit 236 to generate the 3D eyeglasses model 399 in accordance with some embodiments.

In some embodiments, the 3D surface coordinates that correspond to the inner surfaces and the outer surfaces may be computed by inner surface and outer surface construction unit 236 by converting the image pixel coordinates using the component markers (e.g., frontal frame marker 331, frontal frame marker 332, and temple marker 336) and the dimensions of the associated components from the eyeglasses specifications 117. In some embodiments, for example, using the image width between frontal frame markers (e.g., frontal frame marker 331 and frontal frame marker 332 corresponding to the left and right hinge center points) and physical dimension of the two points (distance between the left/right hinge center points), the x-scale is computed by the contour surface construction unit 225 to convert the image points' x-coordinates to 3D x-coordinates. Similarly, using the lens height (e.g., distance between top and bottom points of the lens) and the detected lens contour height, y-scale is computed by inner surface and outer surface construction unit 236 to convert the image y-coordinates to 3D y-coordinates.

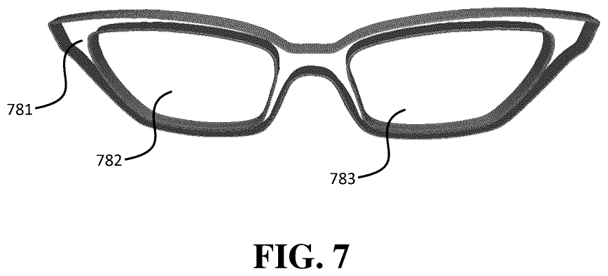

In some embodiments, after the inner and outer surfaces have been generated by inner surface and outer surface construction unit 236, contour surface construction unit 225 commences the process of generating the contour surfaces (e.g., exterior contour surface 781, lens hole contour surface 782, and lens hole contour surface 783 as illustrated by way of example in FIG. 7) for the 3D eyeglasses model 399. In some embodiments, contour surface construction unit 225 is configured to construct contour surfaces by using surface of revolution techniques (described further herein) and tracing a contour profile along the contours generated by contour extraction unit 227. In some embodiments, the contour profile is a profile that is created with beveled edges provided by the bevel radii for the frontal frame and temples in eyeglasses specification 117. In some embodiments, a contour profile is created by the contour surface construction unit 225 for each contour detected by contour extraction unit 227. Thus, in some embodiments, for each detected contour (e.g., exterior contour 393, a lens hole contour 391, and a lens hole contour 392), a profile is created by the contour surface construction unit 225 with beveled edges provided by the bevel radii for the frontal frame and temples in eyeglasses specification 117.

In some embodiments, a profile created by the contour surface construction unit 225 to generate the 3D eyeglasses model 399 includes two beveled edges (e.g., one on each side). In some embodiments, to construct the lens hole contour surface 782 and lens hole contour surface 783, the direction of the bevels is reversed for the hole contours (e.g., lens hole contour 391 and the lens hole contour 392) versus the exterior contour 393. In some embodiments, the exterior contour surface 781, lens hole contour surface 782, and lens hole contour surface 783 are constructed by contour surface construction unit 225 by creating a surface of revolution and tracing the profile along the corresponding contours. FIG. 7 illustrates the exterior contour surface 781, lens hole contour surface 782, and lens hole contour surface 783 constructed by the contour surface construction unit 225 that are used to generate the 3D eyeglasses model 399 in accordance with some embodiments.

In some embodiments, after each exterior surface and hole contour surface for each component has been constructed by the eyeglasses model generation system 216, the texture maps for each of the components is generated using the texture map generation unit 261. In some embodiments, each of the surfaces has a texture map for colors (and an opacity map for the surface opacity). In some embodiments, the texture maps and opacity maps are usually stored as part of a 4-channel RGBA image. In some embodiments, the texture map generation unit 261 is configured to utilize the source photos (e.g., frontal frame component image 118 and temple component image 119) to generate the texture map for each of the components. In some embodiments, the source photos (e.g., frontal frame component image 118 and temple component image 119) may be resized and cropped by the texture map generation unit 261 and used as the texture map for each of components. In some embodiments, the outer surface and inner surface may share the same texture map, or each may have an individual texture map. In some embodiments, for the contour surfaces, the pixel colors along each contour in the photos are used to color the surface, which creates an effect where a contour point color is extruded to the entire width of the contour surface. In some embodiments, the texture mapping may require storing “U, V coordinates” for each 3D points. In some embodiments, the U, V coordinates are image coordinates that can be found easily from the 3D points (since, for example, the 3D points may be computed from the image points).

In some embodiments, after the texture maps for each of the components have been generated using the texture map generation unit 261, the opacity map generation unit 229 generates opacity maps for each of the components. In some embodiments, the opacity map allows a simple curve surface to represent intricate details of the eyeglasses (e.g., eyewear frame) without being limited by the geometry of the eyeglasses. In some embodiments, for the frontal frame component 381, the outer and inner surfaces are simply composed of the coarse rectangular grid of triangles generated by contour surface construction unit 225. In some embodiments, during the 3D rendering of the 3D eyeglasses model 399, only pixels with non-zero opacity value in the opacity map are displayed on the screen to provide the illusion of a complex shape. In some embodiments, since the opacity maps may be of a significantly higher resolution than the grids generated by the inner surface and outer surface construction unit 236, the rendered details are only limited by the resolution of the opacity maps, and not the resolution of the grids generated by the contour surface construction unit 225.

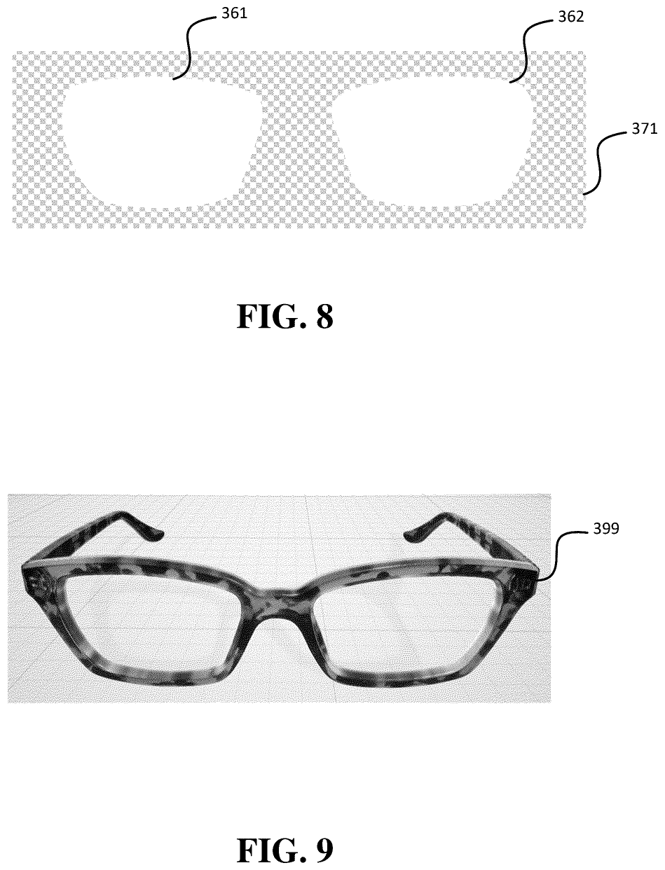

In some embodiments, as stated previously, adding surface context to the lenses (e.g., lens 346 and lens 347) is optional as many eyeglass lenses tend to be transparent. In some embodiments, optional lens surfaces may be added to 3D eyeglasses model 399 by the eyeglasses model generation system 216 when, for example, the lenses are not completely transparent. In some embodiments, the lens surfaces have the same geometry as the holes of the frontal frame component outer surface, however, the lenses utilize an opacity map that is different than the opacity map for the frontal frame component 381, as illustrated in FIG. 8. In some embodiments, the opacity map generation unit 229 is configured to generate the opacity maps for the lenses. In some embodiments, the opacity maps for the lens are constructed by the opacity map generation unit 229 by filling the interior region of the lens contours with non-zero opacity values. In some embodiments, lens gradients may be simulated by varying the opacity values in the lens regions based on the input specifications from the lens gradient minimum and maximum values. In some embodiments, the texture map generation unit 261 may utilize a texture map on the lens surfaces to add a color pattern. FIG. 8 illustrates an opacity map generated by opacity map generation unit 229 and created from the lens contours (e.g., lens contour 361 and lens contour 362) that are used to generate the 3D eyeglasses model 399 in accordance with some embodiments.

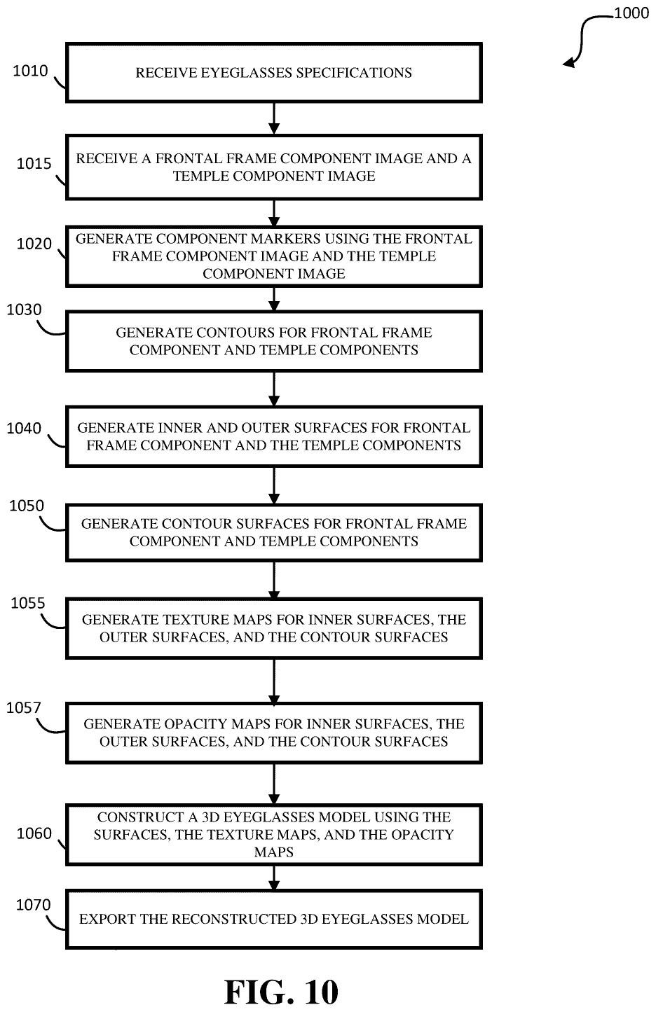

FIG. 10 is a flow diagram illustrating a method 1000 for generating a 3D eyeglasses model 399 in accordance with some embodiments. In some embodiments, the method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the order of some of the steps (e.g., 1020 and 1030; 1040 and 1050; 1055 and 1057) may vary or be interchangeable.

In some embodiments, at block 1010, eyeglasses specifications 117 are received by the eyeglasses model generation system 116. In some embodiments, at block 1015, a frontal frame component image 118 and a temple component image 119 are received by the eyeglasses model generation system 116. In some embodiments, at block 1020, component markers are generated by the eyeglasses model generation system 116 using the frontal frame component image 118 and the temple component image 119.

In some embodiments, at block 1030, contours are generated by the eyeglasses model generation system 116 from the frontal frame component 381 and the temple component 384. In some embodiments, at block 1040, inner surfaces and outer surfaces are generated for the frontal frame component 381 and the temple component 384. In some embodiments, at block 1050, contour surfaces are generated by the eyeglasses model generation system 116 using the frontal frame component 381 and the temple component 384.

In some embodiments, at block 1055, texture maps are generated by the eyeglasses model generation system 116 from the frontal frame component image 118 and the temple component image 119 for the inner surfaces, the outer surfaces, and the contour surfaces. In some embodiments, texture maps may also be generated for the lenses of the eyeglasses 341.

In some embodiments, at block 1057, opacity maps are generated by the eyeglasses model generation system 116 for the inner surfaces, the outer surfaces, and the contour surfaces. In some embodiments, opacity maps may also be generated for the lenses of the eyeglasses 341.

In some embodiments, at block 1060, the 3D eyeglasses model 399 is constructed by the eyeglasses model generation system 116 using the generated surfaces, texture maps, and opacity maps. In some embodiments, at block 1070, the 3D eyeglasses model 399 is exported for use on, for example, a face model of the user of the eyeglasses model generation system 116.

In some embodiments, with reference to FIG. 2, in addition to being prompted to provide the frontal frame component image 118 and the temple component image 119, the user may be prompted by the eyeglasses model generation system 116 to provide additional digital photos to the eyeglasses model generation system 116 when, for example, the left temple component 384 and the right temple component 383 are not symmetrical, or when, for example, the back side surfaces of the frontal frame component 381 or temple component 384 are different than the front side surfaces of the frontal frame component 381 or temple component 384. In some embodiments, the eyeglasses model generation system 116 utilizes the additional images to generate the 3D eyeglasses model 399.

In some embodiments, the location and distance between the markers are provided via physical measurements or manufacturing specifications in order to create 3D eyeglasses models with an appropriate size.

In some embodiments, a simplified 3D representation of eyeglasses model is described herein that allows easier reconstruction of the 3D models from a small number of photos captured by photo-based eyewear capturing systems. In some embodiments, the generated 3D eyeglasses model generation is an improvement over other 3D generation techniques in that the simplified 3D eyeglasses model generated are suitable for rendering with graphics hardware found in consumer level devices or smartphones and provide sufficient level of details for online browsing or virtual try-on.

In some embodiments, a computer-implemented method includes receiving a frontal frame component image of a frontal frame of a pair of eyeglasses; receiving a temple component image of a temple component of the pair of eyeglasses; and using the frontal frame component image and the temple component image to generate a three-dimensional (3D) eyeglasses model of the pair of eyeglasses.

In some embodiments of the computer-implemented method, component markers, generated based on the frontal frame component image and the temple component image, are used to generate the 3D eyeglasses model.

In some embodiments of the computer-implemented method, physical measurements of the component markers are used to generate the 3D eyeglasses model.

In some embodiments of the computer-implemented method, contours extracted from the frontal frame component image and the temple component image are used to generate the 3D eyeglasses model

In some embodiments of the computer-implemented method, outer surfaces of the 3D eyeglasses model are constructed using the contours extracted from the frontal frame component image and the temple component image.

In some embodiments of the computer-implemented method, the outer surfaces of the 3D eyeglasses model that are constructed using the contours extracted from the frontal frame component image and the temple component image are a frontal frame outer surface, a first temple outer surface, and a second temple outer surface.

In some embodiments of the computer-implemented method, inner surfaces of the 3D eyeglasses model are constructed using the contours extracted from extracted from the frontal frame component image and the temple component image.

In some embodiments of the computer-implemented method, the inner surfaces of the 3D eyeglasses model that are constructed using the contours extracted from extracted from the frontal frame component image and the temple component image are a frontal frame inner surface, a temple inner surface, and temple inner surface.

In some embodiments of the computer-implemented method, grid surfaces are generated using bounding boxes generated around the contours, the grid surfaces being used to generate the 3D eyeglasses model.

In some embodiments of the computer-implemented method, opacity maps are generated for the inner surfaces, the outer surfaces, and contour surfaces, the opacity maps being used to generate the 3D eyeglasses model.

In some embodiments of the computer-implemented method, texture maps are generated for the inner surfaces, the outer surfaces, and the contour surfaces, the texture maps being used to generate the 3D eyeglasses model.

In some embodiments, a system includes a processor; and a memory in communication with the processor for storing instructions, which when executed by the processor causes the system to: receive a frontal frame component image of a frontal frame of a pair of eyeglasses; receive a temple component image of a temple component of the pair of eyeglasses; and use the frontal frame component image and the temple component image to generate a three-dimensional (3D) model of the pair of eyeglasses.

In some embodiments of the system, component markers, generated based on the frontal frame component image and the temple component image, are used to generate the 3D eyeglasses model.

In some embodiments of the system, contours are extracted from the frontal frame component image and the temple component image.

In some embodiments of the system, the contours extracted from the frontal frame component image and the temple component image are used to generate the 3D eyeglasses model.

In some embodiments of the system, outer surfaces of the 3D eyeglasses model are constructed using the contours extracted from extracted from the frontal frame component image and the temple component image.

In some embodiments of the system, the outer surfaces of the 3D eyeglasses model that are constructed using the contours extracted from extracted from the frontal frame component image and the temple component image are a frontal frame outer surface, a first temple outer surface, and a second temple outer surface.

In some embodiments, a three-dimensional (3D) eyeglasses model generation system includes a component marker generation unit; a contour extraction unit coupled to the component marker generation unit; and a surface construction unit coupled to the contour extraction unit, wherein component markers generated by the component marker generation unit and contours extracted by the contour extraction unit are used by the surface construction unit to generate a 3D eyeglasses model.

In some embodiments of the 3D eyeglasses model generation system, component markers, generated based on the frontal frame component image and the temple component image, are used to generate the 3D eyeglasses model.

In some embodiments of the 3D eyeglasses model generation system, the contours extracted from the frontal frame component image and the temple component image are used to generate the 3D eyeglasses model.

1. A computer-implemented method, comprising:
receiving a frontal frame component image of a frontal frame of a pair of eyeglasses;
receiving a temple component image of a temple component of the pair of eyeglasses; and
using the frontal frame component image and the temple component image to generate a three-dimensional (3D) eyeglasses model of the pair of eyeglasses.

2. The computer-implemented method of claim 1, wherein:
component markers, generated based on the frontal frame component image and the temple component image, are used to generate the 3D eyeglasses model.

3. The computer-implemented method of claim 2, wherein:
physical measurements of the component markers are used to generate the 3D eyeglasses model.

4. The computer-implemented method of claim 3, wherein:
contours extracted from the frontal frame component image and the temple component image are used to generate the 3D eyeglasses model.

5. The computer-implemented method of claim 4, wherein:
outer surfaces of the 3D eyeglasses model are constructed using the contours extracted from the frontal frame component image and the temple component image.

6. The computer-implemented method of claim 5, wherein:
the outer surfaces of the 3D eyeglasses model that are constructed using the contours extracted from the frontal frame component image and the temple component image are a frontal frame outer surface, a first temple outer surface, and a second temple outer surface.

7. The computer-implemented method of claim 6, wherein:
inner surfaces of the 3D eyeglasses model are constructed using the contours extracted from extracted from the frontal frame component image and the temple component image.

8. The computer-implemented method of claim 7, wherein:
the inner surfaces of the 3D eyeglasses model that are constructed using the contours extracted from extracted from the frontal frame component image and the temple component image are a frontal frame inner surface, a temple inner surface, and temple inner surface.

9. The computer-implemented method of claim 8, wherein:
grid surfaces are generated using bounding boxes generated around the contours, the grid surfaces being used to generate the 3D eyeglasses model.

10. The computer-implemented method of claim 9, wherein:
opacity maps are generated for the inner surfaces, the outer surfaces, and contour surfaces, the opacity maps being used to generate the 3D eyeglasses model.

11. The computer-implemented method of claim 10, wherein:
texture maps are generated for the inner surfaces, the outer surfaces, and the contour surfaces, the texture maps being used to generate the 3D eyeglasses model.

12. A system, comprising:
a processor; and
a memory in communication with the processor for storing instructions, which when executed by the processor, cause the system to:
receive a frontal frame component image of a frontal frame of a pair of eyeglasses;
receive a temple component image of a temple component of the pair of eyeglasses; and
use the frontal frame component image and the temple component image to generate a three-dimensional (3D) eyeglasses model.

13. The system of claim 12, wherein:
component markers, generated based on the frontal frame component image and the temple component image, are used to generate the 3D eyeglasses model.

14. The system of claim 13, wherein:
contours are extracted from the frontal frame component image and the temple component image.

15. The system of claim 14, wherein:
the contours extracted from the frontal frame component image and the temple component image are used to generate the 3D eyeglasses model.

16. The system of claim 15, wherein:
outer surfaces of the 3D eyeglasses model are constructed using the contours extracted from extracted from the frontal frame component image and the temple component image.

17. The system of claim 16, wherein:
the outer surfaces of the 3D eyeglasses model that are constructed using the contours extracted from extracted from the frontal frame component image and the temple component image are a frontal frame outer surface, a first temple outer surface, and a second temple outer surface.

18. A three-dimensional (3D) eyeglasses model generation system, comprising:
a component marker generation unit;
a contour extraction unit coupled to the component marker generation unit; and
a surface construction unit coupled to the contour extraction unit, wherein component markers generated by the component marker generation unit and contours extracted by the contour extraction unit are used by the surface construction unit to generate a 3D eyeglasses model.

19. The 3D eyeglasses model generation system of claim 18, wherein:
component markers, generated based on the frontal frame component image and the temple component image, are used to generate the 3D eyeglasses model.

20. The 3D eyeglasses model generation system of claim 19, wherein:
the contours extracted from the frontal frame component image and the temple component image are used to generate the 3D eyeglasses model.

21. A non-transitory computer readable storage medium including instructions that, when executed by a computing device, cause the computing device to:
receive a frontal frame component image of a frontal frame of a pair of eyeglasses;
receive a temple component image of a temple component of the pair of eyeglasses; and
use the frontal frame component image and the temple component image to generate a three-dimensional (3D) eyeglasses model of the pair of eyeglasses.
